(19) United States
(12) Patent Application Publication
(10) Pub. No.: US 2024/0081583 A1
(43) Pub. Date: Mar. 14, 2024

(54) DEVICE FOR PROCESSING LOOSE COFFEE

(71) Applicant: DE' LONGHI APPLIANCES S.r,l., Treviso (IT)

(72) Inventors: Giovanni ROSSETTO, Treviso (IT); Roberto SANSON, Treviso (IT)

(73) Assignee: DE' LONGHI APPLIANCES S.r.l., Treviso (IT)

(21) Appl. No.: 18/264,044

(22) PCT Filed: Jan. 28, 2022
(86) PCT No.: PCT/EP2022/052001

§ 371 Date: Aug. 2, 2023

(30) Foreign Application Priority Data
Feb. 5, 2021 (IT) 102021000002576

(51) Int. Cl. A47J 42/44; A47J 31/06; A47J 31/42; A47J 31/44; A47J 31/52; A47J 42/40

(52) U.S. Cl. CPC A47J 42/44; A47J 31/0663; A47J 31/42; A47J 31/4464; A47J 31/525; A47J 42/40

(57) ABSTRACT

The device for processing loose coffee comprises an electronic controller, a support, at least one first filter holder that is engageable with the support, at least one first filter, wherein the first filter holder comprises a cup where the first filter is housed, wherein the cup has at least two wings engaging the first filter holder with the support, means for the automatic recognition of the first filter being provided positioned in the first filter holder engaged with the support, the recognition means being connected to the electronic controller to program an operation with at least one parameter depending on the first recognized filter.

### CROSS-REFERENCE TO RELATED APPLICATIONS

The present application is a U.S. national phase application under 35 U.S.C. § 371 of International Patent Application No. PCT/EP2022/052001, filed Jan. 28, 2022, which claims priority to Italian Patent Application No. 102021000002576, filed Feb. 5, 2021. The entire contents of which are hereby incorporated by reference.

### FIELD OF THE INVENTION

The present invention relates to a device for processing loose coffee, which can be integrated in a grinder or in another system of the type comprising a filter holder adapted to contain ground coffee, where the ground coffee is housable in interchangeable filters having different capacities.

### BACKGROUND

In the world of professional coffee machines, technical solutions for the recognition of the filter holder are provided in order to automate some functions of the machine, such as the automatic dispensing of the correct dose of ground coffee, the inhibition of some functions if the filter holder is not present, etc. These technical recognition solutions are obtained by exploiting the particular surfaces on the filter holder cup or the presence of different spouts, but in any case they involve the use of several different filter holders, for example a dedicated filter holder for dispensing single doses of ground coffee and one for dispensing double doses of ground coffee.

In the world of coffee machines for domestic use, on the other hand, due to cost needs, only one filter holder and two interchangeable filters with different capacities are provided.

To correctly dispense the ground coffee, the user must place the correct filter in the cup and make the correct selection on the interface dashboard of the grinding device.

Having to perform a manual operation and above all having to visually distinguish two filters which are often very similar to each other, the user often makes mistakes. In addition to the annoying need to check the type of filter inserted, the mistake involves the execution of a low-quality brewed coffee.

For example, if a double coffee is requested and a single dose of ground coffee is selected by mistake, the user will have to repeat the operation.

The technical task of the present invention is therefore to realize a device for processing loose coffee which makes it possible to eliminate the decried technical drawbacks of the prior art.

As part of this technical task, an object of the invention is to assist the user and reduce the possibility of programming errors.

Another object of the invention is to increase the automation of the device for processing loose coffee.

A still further object of the invention is to provide a device for processing loose coffee which is easy to use.

### SUMMARY

The technical task, as well as these and other objects are achieved according to the present invention by a device for processing loose coffee comprising an electronic controller, a support, at least one first filter holder that is engageable with the support, at least one first filter, where the first filter holder comprises a cup where the first filter is housed, wherein the cup has at least two wings engaging the first filter holder with the support, characterized in that it comprises means for the automatic recognition of at least one first filter positioned in the first filter holder engaged with the support, said recognition means being connected to the electronic controller to program an operation with at least one parameter depending on said at least a first recognized filter. In one embodiment of the invention, the device for processing loose coffee comprises a first filter and a second filter having a different capacity and being housable in an interchangeable manner in the cup, said recognition means being configured to recognize automatically which of the first and the second filter is positioned in the filter holder engaged with the support to program an operation with at least one parameter depending on which of the first and the second filter has been recognized.

In one embodiment of the invention, the device is integrated in a grinder where said support is formed by a ground coffee dispenser of the grinder, and said electronic controller is configured to program a dispensing of a quantity of ground coffee corresponding to the capacity of the recognized filter.

In one embodiment of the invention, the device is integrated in a coffee machine. In one embodiment of the invention the device for processing loose coffee is integrated in a tamper.

The advantage in the world of household devices derives above all from the economic side, since with the present invention the automatic recognition of an interchangeable filter is obtained, while the filter holder used is always the same.

In one embodiment of the invention, where the first filter has single capacity and the second filter has double capacity, said controller programs a dispensing of a single dose of ground coffee if the first filter is recognized or the dispensing of a double dose of ground coffee if the second filter is recognized.

In one embodiment of the invention, the first filter and respectively the second filter have a first perimeter flange and respectively a second perimeter flange configured to rest on an upper perimeter edge of the cup, the first perimeter flange having a first configuration identifying the first filter and the second perimeter flange having a second configuration identifying the second filter.

In one embodiment of the invention, said recognition means comprise a probe configured and arranged to distinguish between the first and the second perimeter flange.

In one embodiment of the invention, said probe has a first operating position associated with the identification of the first perimeter flange and a second operating position associated with the identification of the second perimeter flange. In one embodiment of the invention, said recognition means comprises a microswitch configured and arranged to interact with said probe.

In one embodiment of the invention the microswitch is switchable between a first state associated with the first operating position of the probe and a second state associated with the second operating position of the probe.

In one embodiment of the invention, one of the first and the second perimeter flange has locally at least one protrusion that is configured and arranged to protrude radially outside the upper perimeter edge of the cup and to interact with said probe.

In one embodiment of the invention said radial protrusion is obliged to superimpose one of said wings.

In one embodiment of the invention, a sensor is provided for the presence of the filter holder engaged with the ground coffee dispenser.

The present invention further relates to a method for grinding coffee beans with a grinding device comprising grinders, an electronic controller, a ground coffee dispenser, a filter holder, a first filter and a second filter having a different capacity, wherein the filter holder comprises at least one dispensing mouth of brewed coffee, a handle, a cup where the first filter or the second filter is housable in an interchangeable manner, wherein the cup has at least two wings engaging the filter holder with the ground coffee dispenser, characterized in that it comprises the automatic execution of the following steps:
recognizing the filter positioned in the filter holder engaged with the ground coffee dispenser,
programming dispensing of a quantity of ground coffee corresponding to the capacity of the recognized filter; and
performing dispensing of the quantity of ground coffee.

### BRIEF DESCRIPTION OF THE DRAWINGS

Further features and advantages of the invention will more fully emerge from the description of a preferred but not exclusive embodiment of the device according to the invention, illustrated by way indicative and non-limiting example in the accompanying drawings, in which:

FIG. 1 schematically shows a coffee machine where the grinder incorporating the device for processing loose coffee is integrated;

FIG. 2 shows some components of the grinding device;

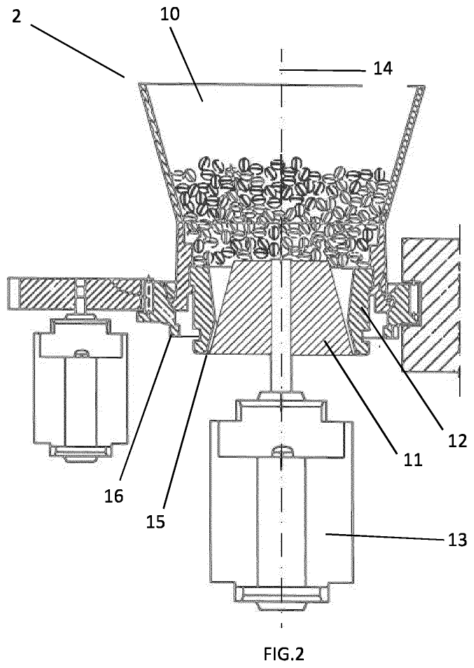

FIG. 3 shows the ground coffee dispenser;

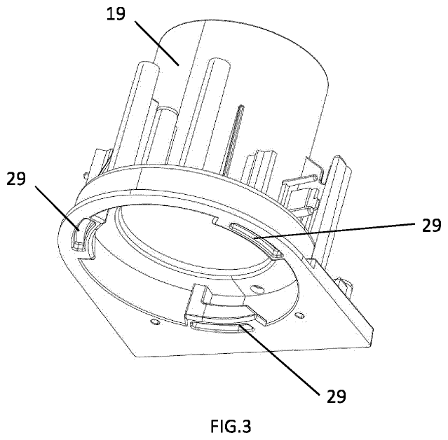

FIG. 4 shows the ground coffee dispenser and the filter holder associated thereto;

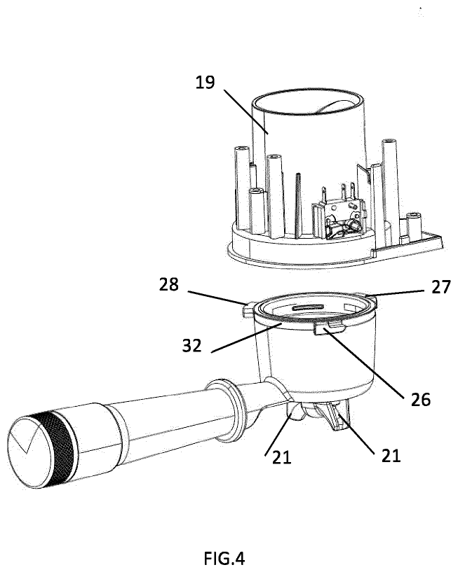

FIG. 5 shows the first filter;

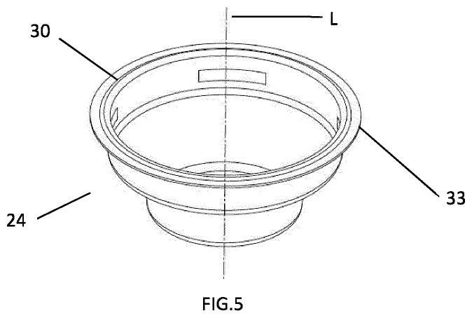

FIG. 6 shows the second filter;

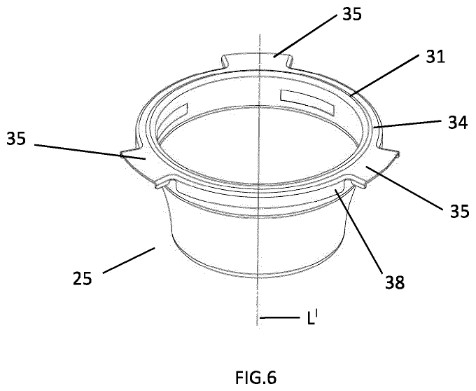

FIG. 7 shows the first filter housed in the filter holder cup;

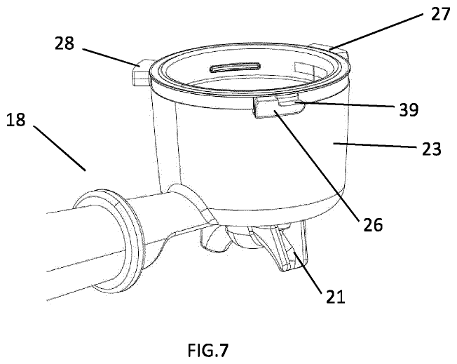

FIG. 8 shows the second filter housed in the filter holder cup;

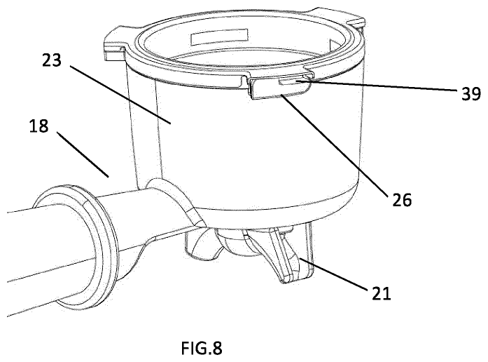

FIG. 9 shows the position of the probe when the first filter is used; and

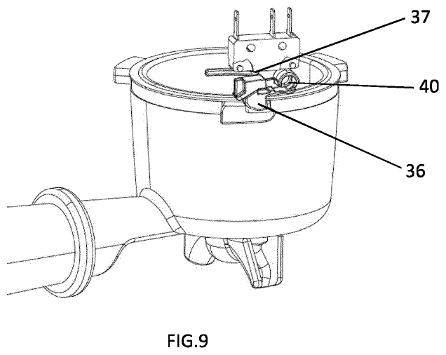

FIG. 10 shows the position of the probe when the second filter is used.

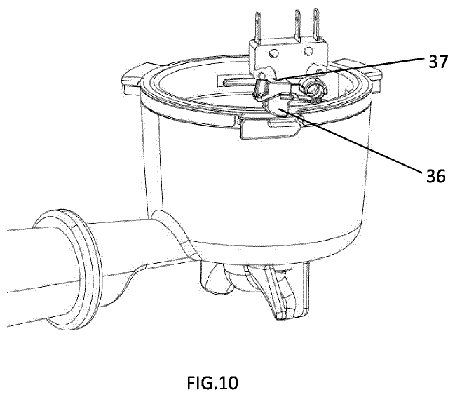

### DETAILED DESCRIPTION

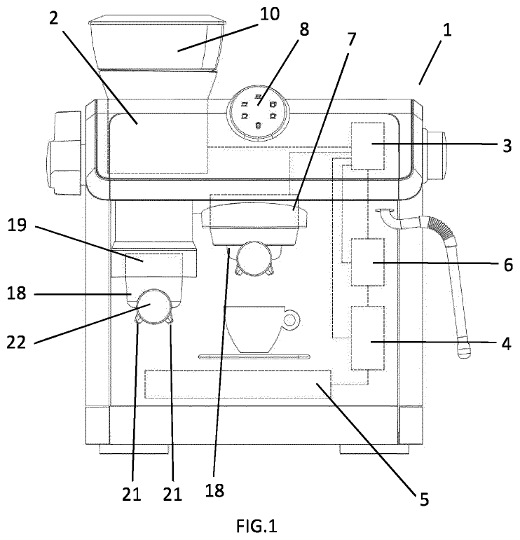

The loose coffee processing device is integrated in a coffee bean grinder 2 which in turn can be of the stand-alone type or, as shown in FIG. 1, can in turn be integrated in a coffee machine 1.

As will be seen in the following, the loose coffee processing device can comprise any system which involves the engagement of a filter holder with interchangeable filters.

The grinder 2 comprises m a known manner an electronic controller 3, a user interface 8, a coffee bean loading hopper 10, grinders 11, 12 which receive the coffee beans from the loading hopper 10, and an electric motor 13 for driving the grinders 11, 12.

The grinders 11, 12 are operable in relative rotation by the electric motor 13.

In particular, the grinder 2 includes a rotating grinder 11 and a non-rotating grinder 12 coaxial with respect to an axis 14 and delimiting a gap 15, which determines the particle size, where the grinding is performed.

The grinder 2 typically also comprises ground coffee particle size adjustment means configured to change the distance between the grinders 11, 12 and also a distance detection sensor between the grinders in communication with the electronic controller 3.

The particle size adjustment means comprises an adjustment ring 16 operable to move the non-rotating grinder 12 parallel to the axis 14 so as to be able to change the width of the gap 15.

A grinder with a construction different from that described above obviously falls within the scope of the invention. The coffee machine 1 in which the grinder 2 is integrated in a known manner comprises a brewing water feed pump 4 connected with suction to a tank 5 or directly to the water mains, with a brewing water heating boiler 6, and with a brewer 7.

In the case illustrated here by way of example in which the grinder 2 is integrated in the coffee machine 1, it is possible to include a single electronic controller 3 and a single user interface 8.

The grinder 2 has a filter holder 18 which can be engaged with a ground coffee dispenser 19 which is also part of the grinder 2.

The grinder 2 further comprises a sensor (not shown) of the presence of the filter holder 18 engaged with the ground coffee dispenser 19, for example a microswitch which is automatically activated due to the engagement of the filter holder 18 with the ground coffee dispenser 19.

The filter holder 18 can also be engaged with the head of the brewer 7 of the coffee machine 1 to proceed with the brewing.

The filter holder 18 comprises one or preferably two spouts 21 for dispensing brewed coffee, a handle 22, a cup 23 where a first filter 24 or a second filter 25 can be interchangeably housed.

The filters 24, 25 have a different capacity, in particular the first filter 24 has a concave body with vertical axis L configured to receive a single dose of ground coffee and the second filter 25 has a concave body with vertical axis L configured to receive a double dose of ground coffee.

More precisely, the body of the first filter 24 has a lower base provided with a distribution of calibrated holes and an open top from which a first flange 30 configured to rest on an upper perimeter edge 32 of the cup 23 of the filter holder 18 extends peripherally, and similarly the body of the second filter 25 has a lower base provided with a distribution of calibrated holes and an open top from which a second flange 31 configured to rest on the circular upper perimeter edge 32 of the cup 23 of the filter holder 18 extends peripherally.

The first flange 30 extends orthogonally to the axis L to surmount the circular upper perimeter edge 32 of the cup 23 of the filter holder 18, and similarly the second perimeter flange 31 extends orthogonally to the axis L to surmount the circular upper perimeter edge 32 of the cup 23 of the filter holder 18.

The flanges 30, 31 also have the function of engaging against a gasket for the hydraulic seal when the filter holder 18 is engaged with the head of the brewer 7 of the coffee machine 1.

The cup 23 has at least two wings, in particular three wings 26, 27, 28 engaging the filter holder 18 with the dispenser 19 of ground coffee 19.

The engagement with the ground coffee dispenser 19 can typically occur with a rototranslational movement, through which the engagement wings 26, 27, 28 engage the ground coffee dispenser 19 through corresponding inner wings 29.

It is clear that the scope of the invention extends to a filter holder with only two engagement wings or to a filter holder with simply translational engagement movement.

Advantageously, according to the invention, the grinder 2 includes means for the automatic recognition of the filter 24, 25 positioned in the filter holder 18 engaged with the ground coffee dispenser 19. The recognition means is connected to the electronic controller 3 for programming dispensing of a quantity of ground coffee corresponding to the capacity of the recognized filter 24, 25.

More precisely, the electronic controller 3 programs a dispensing of a single dose of ground coffee if the first filter 24 is recognized or a dispensing of a double dose of ground coffee if the second filter 25 is recognized.

The first perimeter flange 30 has a first configuration identifying the first filter 24 and the second perimeter flange 31 has a second configuration identifying the second filter 25.

The first flange 30 is formed by a flat ring 33 coaxial to the axis Land adapted to match the upper perimeter edge 32 of the cup 23 of the filter holder 18.

The second flange 31 is instead formed by a flat ring 34 coaxial to the axis L and adapted to match the upper perimeter edge 32 of the cup 23 of the filter holder 18, and by at least one protrusion 35 of the flat ring 34 configured and arranged to protrude radially outside the upper perimeter edge 32 of the cup 23 of the filter holder 18.

In the case illustrated, three identical protrusions 35 are highlighted by way of non-limiting example.

As will become clearer in the following, the presence or absence of the protrusion(s) 35 is used to discriminate between the first filter 24 and the second filter 25.

To discriminate between the first filter 24 and the second filter 25, in the solution shown it is necessary to ensure the correct angular positioning of the second filter 25 in the cup 23 of the filter holder 18. To this end, special forced positioning means is provided which oblige the second filter 25 to be oriented with the protrusions 35 superimposed on the engagement wings 26, 27, 28.

The forced positioning means specifically comprises a perimeter flap 38 of the second flange 31 which extends vertically downwards between the protrusions 35. In practice, if the orientation of the second filter 25 for introduction into the cup 23 of the filter holder 18 is correct, the protrusions 35 of the second flange 31 rest on the respective engagement wings 26, 27, 28 and the flat ring 34 of the second flange 31 rests on the upper perimeter edge 32 of the cup 23 of the filter holder 18, and the filter holder 18 can thus be engaged with the ground coffee dispenser 19.

If, on the other hand, the orientation of the second filter 25 for introduction into the cup 23 of the filter holder 18 is not correct, the perimeter flap 38 of the second flange 31 interferes with the engagement wings 26, 27, 28 and the second filter 23 remains in a more raised position from the cup 23 of the filter holder 18, with respect to the previous case, with the consequence that the filter holder 18 cannot be engaged with the ground coffee dispenser 19.

The recognition means comprises a probe 36 and a microswitch 37 configured and arranged to interact with the probe 36.

The probe 36 is configured and arranged to distinguish between the first flange 30 and the second flange 31.

The probe 36 has a first operating position associated with the identification of the first flange 30 and a second operating position associated with the identification of the second flange 31. In particular, the probe 36 is rotatably supported around a pin 40, between the first operating position and the second operating position.

In the rest position, the probe 36 is positioned in the first operating position.

The microswitch 37 is switchable between a first state associated with the first operating position of the probe 36 and a second state associated with the second operating position of the probe 36.

In its first switching state the microswitch 37 opens a signaling electrical circuit and in its second switching state the microswitch 37 closes the signaling electrical circuit.

The ground coffee dispenser 19 supports the probe 36 in a position such that it is vertically aligned above one of the wings 26, 27, 28 of the cup 23 of the filter holder 18 when it is engaged with the ground coffee dispenser 19.

The engagement wing 26 positioned below the probe 36 has a recess 39 at the top. The operation of the loose coffee processing device is briefly as follows.

The user desires a single dose of coffee and places the first filter 24 in the cup 23 of the filter holder 18.

In this case, the angular orientation of the first filter 24 is not required.

During the rototranslational upward movement of the filter holder 18 for the execution of the engagement with the ground coffee dispenser 19, the presence sensor is activated and signals to the controller 3 the presence of the filter holder 18 and the probe 36, not being in the trajectory of the first flange 30 of the first filter 24, remains stationary in its original operating position, finally engaging in the recess 39 of the engagement wing 26 and consequently does not switch the state of the microswitch 37. The controller 3 connects the failure to switch the state of the microswitch 37 to the presence of the first filter 24 and consequently automatically programs and commands the execution of the grinding of a single dose of coffee.

If the user wants a double dose of coffee, he places the second filter 25 in place of the first filter 24 in the cup 23 of the filter holder 18.

In this case, the angular orientation of the first filter 24 is required to allow the filter holder 18 to be engaged with the ground coffee dispenser 19.

During the rototranslational upward movement of the filter holder 18 for the execution of the engagement with the ground coffee dispenser 19, the presence sensor is activated and signals to the controller 3 the presence of the filter holder 18 and the probe 36, now being in the trajectory of the protrusion 35 of the second flange 31 of the second filter 25, is pushed upwards by the aforesaid protrusion 35 until it moves from the first to the second operating position and consequently switches the microswitch 37.

In the state switching of the microswitch 37, the controller 3 recognizes the presence of the second filter 25 and consequently automatically programs and commands the execution of the grinding of a double dose of coffee.

The invention is therefore based on the recognition of the filter.

In the specific case described, the filter is identifiable thanks to its particular shape of the perimeter flange which, as mentioned, is a typical element provided both to give mechanical rigidity to the filter and to obtain the hydraulic seal through a gasket with the head of the brewer 7 of the coffee machine 1.

It should be noted that it is not necessary to include the overlapping positioning of the protrusion 35 to the engagement wing 26. In fact, in a different embodiment it is possible to envisage a positioning of the second filter 25 with the protrusion 35 offset from the engagement wing 26 which can in this case lack the recess 39.

In the illustrated preferred embodiment, the filter recognition means is of the mechanical type, comprising a microswitch cooperating with a probe.

It is understood that the filter can be recognized by optical, magnetic recognition means, etc.

The recognition logic can be used in other systems in which a filter holder is used, for example in automatic tampering systems to automatically drive the force of the ground coffee compression piston present in the filter as a function of the automatically recognized filter.

Finally, the scope can be extended to grinders for professional coffee machines where two filter holders are included each provided with a corresponding filter, where the filters housed in the two filter holders have a different capacity and are recognizable by the automatic recognition means.

1. A device for processing loose coffee comprising an electronic controller, a support, at least one first filter holder that is engageable with the support, at least one first filter, wherein the first filter holder comprises a cup where the first filter is housed, wherein the cup has at least two wings engaging the first filter holder with the support, further comprises means automatic recognition of said at least one first filter positioned in the first filter holder engaged with the support, said recognition being connected to the electronic controller to program an operation with at least one parameter depending on said at least one first recognized filter.

2. The device for processing loose coffee according to claim 1, wherein it comprises a first filter and a second filter having a different capacity and being housable in an interchangeable mode in the cup, said recognition being configured to recognize automatically which of the first and the second filter is positioned in the filter holder engaged with the support to program an operation with at least one parameter depending on which of the first and the second filter has been recognized.

3. A grinder that integrates a device for processing loose coffee according t claim 1, wherein said support consists of a ground coffee dispenser of the grinder, wherein said controller is configured to program the dispensing of a quantity of ground coffee corresponding to the capacity of the recognized filter.

4. A coffee machine that integrates a grinder according to claim 3.

5. A tamper that integrates a device for processing loose coffee according to claim 1.

6. The device for processing loose coffee according to claim 3, wherein the first filter has single capacity and the second filter has double capacity, wherein said controller programs the dispensing of a single dose of ground coffee if the first filter is recognized or the dispensing of a double dose of ground coffee if the second filter is recognized.

7. The device for processing loose coffee according to claim 1, wherein the first filter and respectively the second filter have a first perimeter flange and respectively a second perimeter flange configured to rest on an upper perimeter edge of the cup, wherein the first perimeter flange has a first configuration identifying the first filter and the second perimeter flange 4 has a second configuration identifying the second filter.

8. The device for processing loose coffee according to claim 7, wherein said recognition comprises a probe configured and arranged to distinguish between the first and the second perimeter flange.

9. The device for processing loose coffee according to claim 8, wherein said probe has a first operating position associated with the identification of the first perimeter flange and a second operating position associated with the identification of the second perimeter flange.

10. The device for processing loose coffee according to claim 9, wherein said recognition comprises a microswitch configured and arranged to interact with said probe, said microswitch being switchable between a first state associated with the first operating position of the probe and a second state associated with the second operating position of the probe.

11. The device for processing loose coffee according to claim 8, wherein one of the first and second perimeter flange has locally at least one protrusion that is configured and arranged to protrude radially outside the upper perimeter edge of the cup and to interact with said probe.

12. The device for processing loose coffee according to claim 11, wherein it comprises forced angular positioning means of said second filter in said cup.

13. The device for processing loose coffee according to claim 12, wherein in said forced angular position of said radial protrusion is superimposed on one of said wings.

14. The device for grinding coffee beans according to claim 8, wherein comprising a sensor of the presence of a filter holder engaged with the ground coffee dispenser.

15. A method for grinding coffee beans with a grinder comprising grinders, an electronic controller, a ground coffee dispenser, a filter holder, a first filter and a second filter having a different capacity, wherein the filter holder comprises a cup where the first filter or the second filter are housable in an interchangeable manner, wherein the cup has at least two wings engaging the filter holder with the ground coffee dispenser, characterized in that it comprises the automatic execution of the following steps:
recognizing which of the first and the second filter is positioned in the filter holder engaged with the ground coffee dispenser,
programming dispensing of a quantity of ground coffee corresponding to the capacity of the recognized filter; and
performing dispensing of the quantity of ground coffee.
